(19) United States
(12) Patent Application Publication
(10) Pub. No.: US 2025/0175405 A1
(43) Pub. Date: May 29, 2025

(54) FACILITATING NETWORK DATA PACKET THROUGHPUT WITH IMMEDIATE ACKNOWLEDGEMENT OF RESENT NETWORK DATA PACKETS

(71) Applicant: NetApp, Inc., San Jose, CA (US)

(72) Inventors: Yuepeng Qi, Cary, NC (US); Sai Rajesh Tallamraju, Cary, NC (US)

(73) Assignee: NetApp, Inc., San Jose, CA (US)

(21) Appl. No.: 19/036,275

(22) Filed: Jan. 24, 2025

Related U.S. Application Data
(63) Continuation-in-part of application No. 18/229,116, filed on Aug. 1, 2023.
Application No. 18/229,116 is a continuation of application No. 18/071,364, filed on Nov. 29, 2022, now Pat. No. 11,765,060.
Application No. 18/071,364 is a continuation of application No. 17/456,471, filed on Nov. 24, 2021, now Pat. No. 11,546,238.
(60) Provisional application No. 63/210,404, filed on Jun. 14, 2021.

(51) Int. Cl. H04L 43/0829; H04L 43/0823; H04L 47/36; H04L 47/50

(52) U.S. Cl. CPC H04L 43/0829; H04L 43/0847; H04L 47/365; H04L 47/54

(57) ABSTRACT

Systems and methods for performing immediate acknowledgement (ACK) of resent network data packets are provided. In one example, an immediate ACK of a resent packet may be sent by a receiver node before processing of the resent packet, thereby allowing the sender's Tx queue to be cleared more quickly and allow clients to continue sending requests to the sender without interruption. Additionally, in an ideal situation, the immediate ACK of a given resent data packet may avoid the sender retransmitting one or more of the data packets subsequent to the missing packet. In one example, in order to mitigate the more frequent ACKs transmitted by the receiver, ACKs may be piggybacked on other packets (e.g., heartbeat packets and/or data packets) that would otherwise be sent from the receiver to the sender.

### CROSS-REFERENCE TO RELATED APPLICATIONS

This application is a continuation-in-part of U.S. patent application Ser. No. 18/229,116, filed on Aug. 1, 2023, which is a continuation of U.S. patent application Ser. No. 18/071,364, filed on Nov. 29, 2022, which is a continuation of U.S. patent application Ser. No. 17/456,471, filed on Nov. 24, 2021, now U.S. Pat. No. 11,546,238, which claims the benefit of priority to U.S. Provisional Application No. 63/210,404, filed on Jun. 14, 2021. Each of the foregoing patent applications is hereby incorporated by reference in its entirety for all purposes.

### BACKGROUND

### Field

Various embodiments of the present disclosure generally relate to networked storage systems. In particular, some embodiments relate to immediate acknowledgement of resent packets, which allows the sender's transmit queue to be cleared more quickly to allow clients to continue sending more requests and thereby improve latency and throughput.

### Description of the Related Art

Various forms of storage systems are used today including direct attached storage, network attached storage (NAS) systems, storage area networks (SANs), and others. Storage systems are commonly used for a variety of purposes, such as providing multiple users with access to shared data, backing up data and others.

A storage system typically includes at least one computing system (may also be referred to as a “server”, “storage server”, “storage node”, “storage system node” or “storage controller”) executing a storage operating system configured to store and retrieve data on behalf of one or more computing systems to or from one or more storage devices. The storage operating system exports data stored on the storage devices as a storage volume.

To provide redundancy in networked storage systems (e.g., a distributed storage system), a first storage system node and a second storage system node can be configured to operate in a high-availability (HA) configuration (e.g., HA configuration with no shared storage) as HA partner nodes. This means that all write operations managed by the first storage system node are mirrored at the second storage system node (and vice versa). If the first storage system node fails, then the second storage system node takes over the storage of the failed first storage system node by executing a failover (also referred to as “takeover” throughout this specification) operation.

The Remote Direct Memory Access (RDMA) protocol may be used to transfer data between the first storage system node and the second storage system node. In conventional systems, to send data to the second storage system node (which may be referred to herein as the receiver or the target), the first storage system node (which may be referred to herein as the sender or the source), operating as an initiator splits the data payload into multiple data packets. The second storage system node acknowledges a successful data transfer by sending an acknowledgement packet (which may be referred to as an “ACK” packet). If the second storage system node does not receive a specific packet, it may send a negative acknowledgement (or non-acknowledgement) packet (which may be referred to as a “NACK” packet) to the first storage system node indicating that the packet was not received.

### SUMMARY

Systems and methods are described for performing immediate acknowledgement of resent network data packets. According to one embodiment, a sender node and a receiver node provide access to storage via a cloud environment. Multiple data packets are received by the receiver node from the sender node in which a given data packet includes a portion of data of a transaction payload being mirrored to the receiver node and an offset value indicating a position of the portion of data within the transaction payload. The sender node buffers within a transmit data structure those of the data packets for which receipt by the receiver node has yet to be acknowledged. Freeing of space within the transmit data structure of the sender node is facilitated by the receiver node by acknowledging receipt by the receiver node of a retransmitted data packet by the sender node prior to the receiver node processing the retransmitted data packet.

Other features of embodiments of the present disclosure will be apparent from accompanying drawings and detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a flow diagram illustrating operations for resending missing packets during a network transmission in accordance with an embodiment of the present disclosure.

FIG. 2 is a block diagram illustrating an example of an overall operating environment for various aspects of the present disclosure.

FIG. 3 is a block diagram illustrating an example of two storage system nodes operating as partner nodes in accordance with an embodiment of the present disclosure.

FIG. 4 is a block diagram illustrating an example of a clustered storage system with multiple storage system nodes in accordance with an embodiment of the present disclosure.

FIG. 5 is a block diagram illustrating an example of a storage operating system executed by a storage system node in accordance with an embodiment of the present disclosure.

FIG. 6 is a flow diagram illustrating operations for performing an immediate ACK of resent packets in accordance with an embodiment of the present disclosure.

FIG. 7 is a message sequence diagram illustrating example interactions between a sender node and a receiver node in accordance with an embodiment of the present disclosure.

FIG. 8 is a block diagram illustrating an example of a storage system node in accordance with an embodiment of the present disclosure.

FIG. 9 is a block diagram illustrating an example of a processing system that may be used according to various aspects of the present disclosure.

### DETAILED DESCRIPTION

Systems and methods are described for performing immediate acknowledgement of resent network data packets. As noted above, in certain HA configurations, data storage by HA partners may be mirrored between a first storage system node and a second storage system node of a distributed storage system to allow one storage system node (e.g., a surviving storage system node) to takeover servicing of storage access requests made on behalf of clients to the other storage system mode (e.g., a failed storage system node). In some distributed storage systems, when a packet of a payload is not affirmatively acknowledged by the second storage system node as having been received from the first storage system node or is negatively acknowledged as not having been received from the first storage system node, the first storage system node resends the entire payload. For example, assume that the first storage system node splits a payload into 10 different packets. Assuming, the second storage system node does not receive packet 5 and sends a NACK regarding packet 5. Responsive to the first storage system node receiving the NACK, it resends packets 1-10. This approach of resending the entire payload is inefficient because it unnecessarily consumes network bandwidth and computing resources, which is undesirable. A more efficient approach involves resending only the missing packet and the subsequent packets of the payload, in the previous example, packets 5-10. This approach may be referred to herein as a partial send or a partial resend.

While the partial resend is better than the prior approach, three remains additional room for improved efficiencies. For example, the receiver (e.g., the second storage system in the examples above) generally processes sequences of consecutive packets of the payload received from the sender (e.g., the first storage system node in the examples above) and implements a future data structure (e.g., a future queue or buffer) that maintains packets of the payload that have been successfully received, but have not yet been processed. So, in the example above in which packet 5 was not received, packets 1-4 would be processed by the receiver, packets 6-10 would be stored in the future queue of the receiver, and after packet 5 has been resent by the sender and successfully received by the receiver, the receiver may then process packets 5-10. After processing packets 5-10, the receiver then ACKs receipt of packets 5-10, for example, by sending an ACK of packet 10. Notably, during the time the receiver is processing packets 5-10, the sender is awaiting acknowledgement of packets 5-10, so these packets all remain in a transmit (Tx) data structure (e.g., a Tx queue or buffer of limited size) implemented on the sender. Meanwhile, the sender will continue with the resending of the packets subsequent to the missing packet (i.e., packets 6-10). As clients may continue sending storage access requests to the sender, the sender's Tx queue may become full, thereby precluding additional requests to be received by the sender.

In order to allow the sender's Tx queue to be cleared faster, embodiments herein propose an immediate ACK of a resent packet (and subsequent uninterrupted sequence of packets of the payload already successfully received, if any) by the receiver before processing of the resent packet (and subsequent uninterrupted sequence of packets of the payload already successfully received, if any). In this manner, the receiver's ACK of a given resent packet (which may be referred to herein as an “immediate ACK”) is sent in a more timely manner to the sender, thereby allowing the sender's Tx queue to more quickly be cleared and allow clients to continue sending requests to the sender without interruption. Additionally, in the context of the present example, in an ideal situation, the immediate ACK of packet 5 may avoid the sender retransmitting the packets (i.e., packets 6-10) subsequent to the missing packet. While this immediate ACK approach is likely to result in more frequent ACKs issued by the receiver, this can be mitigated by piggybacking the ACKs on other packets that would otherwise be sent from the receiver to the sender as described further below. For example, the ACKs may be included within heartbeat packets and/or data packets (e.g., carrying mirrored data stored by the receiver to the sender).

Various embodiments of the present technology provide for a wide range of technical effects, advantages, and/or improvements to computing systems and components. For example, various embodiments may include one or more of the following technical effects, advantages, and/or improvements: 1) non-routine and unconventional modification of communication protocols to minimize payload resends and related data structure management in storage systems; 2) dynamic integration of partial resends and receipt acknowledgments to allow the sender's Tx queue to more quickly be cleared and allow clients to continue sending requests to the sender without interruption; 3) use non-routine and unconventional computer operations to more efficiently perform immediate acknowledgement of resent network data packets; and 4) modification of communication protocols to more efficiently handle missing packets.

In the following description, numerous specific details are set forth in order to provide a thorough understanding of embodiments of the present disclosure. It will be apparent, however, to one skilled in the art that embodiments of the present disclosure may be practiced without some of these specific details. In other instances, well-known structures and devices are shown in block diagram form.

### Terminology

Brief definitions of terms used throughout this application are given below.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition. For example, when two computer systems of storage nodes are said to be communicably coupled herein, this may refer to a direct connection, a network connection, or other connections to enable communication therebetween.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

As used herein a “cloud” or “cloud environment” broadly and generally refers to a platform through which cloud computing may be delivered via a public network (e.g., the Internet) and/or a private network. The National Institute of Standards and Technology (NIST) defines cloud computing as “a model for enabling ubiquitous, convenient, on-demand network access to a shared pool of configurable computing resources (e.g., networks, servers, storage, applications, and services) that can be rapidly provisioned and released with minimal management effort or service provider interaction.” P. Mell, T. Grance, The NIST Definition of Cloud Computing, National Institute of Standards and Technology, USA, 2011. The infrastructure of a cloud may be deployed in accordance with various deployment models, including private cloud, community cloud, public cloud, and hybrid cloud. In the private cloud deployment model, the cloud infrastructure is provisioned for exclusive use by a single organization comprising multiple consumers (e.g., business units), may be owned, managed, and operated by the organization, a third party, or some combination of them, and may exist on or off premises. In the community cloud deployment model, the cloud infrastructure is provisioned for exclusive use by a specific community of consumers from organizations that have shared concerns (e.g., mission, security requirements, policy, and compliance considerations), may be owned, managed, and operated by one or more of the organizations in the community, a third party, or some combination of them, and may exist on or off premises. In the public cloud deployment model, the cloud infrastructure is provisioned for open use by the general public, may be owned, managed, and operated by a cloud provider or hyperscaler (e.g., a business, academic, or government organization, or some combination of them), and exists on the premises of the cloud provider. The cloud service provider may offer a cloud-based platform, infrastructure, application, or storage services as-a-service, in accordance with a number of service models, including Software-as-a-Service (SaaS), Platform-as-a-Service (PaaS), and/or Infrastructure-as-a-Service (IaaS). In the hybrid cloud deployment model, the cloud infrastructure is a composition of two or more distinct cloud infrastructures (private, community, or public) that remain unique entities, but are bound together by standardized or proprietary technology that enables data and application portability (e.g., cloud bursting for load balancing between clouds).

As used herein, a “storage system” or “storage appliance” generally refers to a type of computing appliance or node, in virtual or physical form, that provides data to, or manages data for, other computing devices or clients (e.g., applications). The storage system may be part of a cluster of multiple nodes representing a distributed storage system. In various examples described herein, a storage system may be run (e.g., on a VM or as a containerized instance, as the case may be) within a public cloud provider.

As used herein, the term “storage operating system” generally refers to computer-executable code operable on a computer to perform a storage function that manages data access and may, in the case of a storage system node, implement data access semantics of a general-purpose operating system. The storage operating system can also be implemented as a microkernel, an application program operating over a general-purpose operating system, such as UNIX® or Windows®, or as a general-purpose operating system with configurable functionality, which is configured for storage applications as described herein.

As used herein, a “heartbeat packet” or simply a “heartbeat” generally refers to a message exchanged between the nodes of a high-availability (HA) pair (e.g., a primary storage node and a secondary storage node) to facilitate a determination regarding whether to trigger a failover or a failback. Timely receipt of a periodic heartbeat from an HA partner node is generally indicative of the liveness of the HA partner node, whereas missing one or more heartbeats (e.g., a heartbeat failure and a configurable number of retries) from the HA partner node may be indicative of a need for a secondary node to take over responsibility for storage operations currently being directed to the primary node. Depending on the particular implementation, the heartbeat packet may contain information about the current status of the originating node, including, for example, a node identifier (ID), the system uptime, and a timestamp.

As used herein, “processing” of a data packet or a contiguous sequence of data packets of which the data packet is a part generally refers to the receiver node's performance of an RDMA operations (e.g., write, read/read reply, send, or receive) specified by the data packet or the contiguous sequence of data packets. For example, when processing a given data packet, the receiver identifies the type of RDMA operation and then performs the corresponding RDMA operation on the data at the RDMA target memory address specified in the given data packet. For RDMA operations, such as read reply, or receive, once the RDMA operation is completed, a completion event is generated and added to a completion queue. Applications in the Upper Layer Protocol (ULP) are then notified or may poll for the completion of the RDMA operation. For purposes of clarity, the receipt and/or buffering of a data packet by the receiver node within a future data structure or an Rx data structure is not considered part of the processing of a data packet.

As used herein, a “cloud volume” generally refers to persistent storage that is accessible to a virtual storage system by virtue of the persistent storage being associated with a compute instance in which the virtual storage system is running. A cloud volume may represent a hard-disk drive (HDD) or a solid-state drive (SSD) from a pool of storage devices within a cloud environment that is connected to the compute instance through Ethernet or fibre channel (FC) switches as is the case for network-attached storage (NAS) or a storage area network (SAN). Non-limiting examples of cloud volumes include various types of SSD volumes (e.g., AWS Elastic Block Store (EBS) gp2, gp3, io1, and io2 volumes for EC2 instances) and various types of HDD volumes (e.g., AWS EBS st1 and sc1 volumes for EC2 instances).

As used herein, “component”, “module”, “system,” and the like are intended to refer to a computer-related entity, either software-executing general-purpose processor, hardware, firmware and a combination thereof. For example, a component may be, but is not limited to being, a process running on a hardware processor, a hardware processor, an object, an executable, a thread of execution, a program, and/or a computer. By way of illustration, both an application running on a server and the server can be a component. One or more components may reside within a process and/or thread of execution, and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). Computer executable components can be stored, for example, at non-transitory, computer readable media including, but not limited to, an ASIC (application specific integrated circuit), CD (compact disc), DVD (digital video disk), ROM (read only memory), floppy disk, hard disk, storage class memory, solid state drive, EEPROM (electrically erasable programmable read only memory), memory stick or any other storage device type, in accordance with the claimed subject matter.

### Overview

In one aspect, innovative network technology for handling missing network packets is provided. A first storage system node receives a payload to send to a second storage system node. The term node may be used herein as a generic reference to a “storage node,” “network node”, “computing system”, “host”, “host computing system”, “initiator” or “target”. The first node (the sender in this example) splits the payload into multiple data packets, where each data packet has a portion of the payload. The number of data packets for the payload depends on a maximum transmission unit (MTU) size used by a network interface of the first and second node, respectively, and the overall size of the payload. To transmit the data packets, the first storage node is aware of an offset of each data packet within the payload (i.e., the offset or position of the portion of the payload of each data packet). As an example, the offset is a starting point in bytes of data that each data packet holds. The packet size is typically equal to the MTU size.

The first node sends the data packets to the second node (the receiver in this example) as part of a transfer operation that is uniquely identified by a transaction identifier. Each data packet transmitted by the first node includes an RDMA header that specifies the total payload size and an offset value. If the second node successfully receives all the packets, then the second node transmits an ACK packet, acknowledging/confirming receipt of the series of packets, to the first node to complete the transfer operation.

If the second node does not receive a specific packet, e.g., packet 5 out of a transmission of 10 packets, then the second node may transmit a NACK to the first node indicating the offset of the missing data payload of the missing data packet. The first node receives the NACK with the offset and only resends packets from the offset specified therein. For example, if packet 5 is missing, then the first node only sends packets 5-10, rather than transmitting all 10 packets, as performed by conventional networking systems. Because only a portion of the payload is resent, the network bandwidth usage is less vis-à-vis resending the entire payload.

Furthermore, as described below in detail, embodiments disclosed herein need not use individual packet numbers or a counter to track if a packet is missing, which can be resource intensive and cause synchronization issues vis-à-vis using offset values to detect missing packets. This saves overall processing resources and provides flexibility for both nodes.

Before, describing the details of the various aspects of the present disclosure, some background information regarding RDMA technology, also referred to as the “RDMA protocol” may be helpful. For executing RDMA operations, the first node may operate as an initiator and the second node may operate as a target. Using a network interface card, the first node initiates a network connection with the second node that typically accepts the connection. During the connection negotiations, both nodes set a MTU for packet transmission. As an example, the first and second node negotiate the MTU size based on available network link ability, the capability of each node to transmit data packets and process received data packets or any other parameter.

Both the nodes execute a processor executable, RDMA layer to support RDMA operations defined by the RDMA protocol. The RDMA layer enables an RDMA send, RDMA read and RDMA write operation using the RDMA send, RDMA read, and RDMA write primitives that are defined by the RDMA protocol. For example, an RDMA send operation transfers data from a memory buffer at the first node to a memory buffer at the second node. The memory buffer at the second node is not advertised by the second node. An RDMA read operation requests transfer (read) of information from a memory buffer at the second node directly to a memory buffer at the first node. An RDMA write operation transfers data from a memory buffer at the first node directly to a memory buffer at the second node. Unlike the RDMA send operation, the memory buffer at the second node, for the RDMA write operation is advertised by the second node for an RDMA operation.

Both nodes create a protection domain (PD) to associate memory regions with Queue Pairs (QPs). The term QP as used herein includes a structure that maintains a send queue (which may be more generally referred to herein as a Tx data structure) and a receive queue (which may be more generally referred to herein as an Rx data structure) for managing work requests. A PD is typically represented by a unique identifier. The standard use of a PD is described by the RDMA specification. After creating the PD, memory registration is executed to enable direct network interface access to pre-defined memory locations. Both nodes register one or more memory locations (which may also be referred to herein as buffers or memory buffers) with each other so that information can be directly placed to or accessed from the registered memory location. Typically, an operating system of each node registers the memory locations as defined by the RDMA protocol. A registered directly accessible memory location is referred to as a “Memory Region”.

During memory registration, a memory key structure is also generated. The memory key structure includes a memory key for authenticating access to a Memory Region. The memory key format/value depends on the type of network protocol, for example, InfiniBand (IB), Internet Wide Area RDMA Protocol (iWARP), RDMA over Converged Ethernet (RoCE), RoCEv2 or any other protocol that is used in conjunction with the RDMA protocol.

IB is typically used to create fabrics with interconnected hosts/switches/servers. The IB Specification is published by the InfiniBand Trade Association (IBTA) and provides support for RDMA operations.

iWARP is defined by the Internet Engineering Task Force (IETF). iWARP includes a collection of protocols for enabling RDMA based operations over Transmission Control Protocol (TCP) networks. These protocols include Marker Protocol Data Unit Aligned Framing for TCP (MPA), Direct Data Placement (DDP), and the RDMA protocol. The DDP protocol allows data to be placed directly into assigned memory buffers using network protocols, for example, TCP/Internet Protocol (IP) and others.

RoCE is a network protocol that enables RDMA over an Ethernet network. This is enabled by encapsulating an IB transport packet over an Ethernet packet. There are two RoCE versions, RoCE v1 and RoCE v2. RoCE v1 is an Ethernet link layer protocol and hence allows communication between any two nodes in the same Ethernet broadcast domain. RoCE v2 is an Internet layer protocol which means that RoCE v2 packets can be routed.

### Example Missing Packet Resend Processing

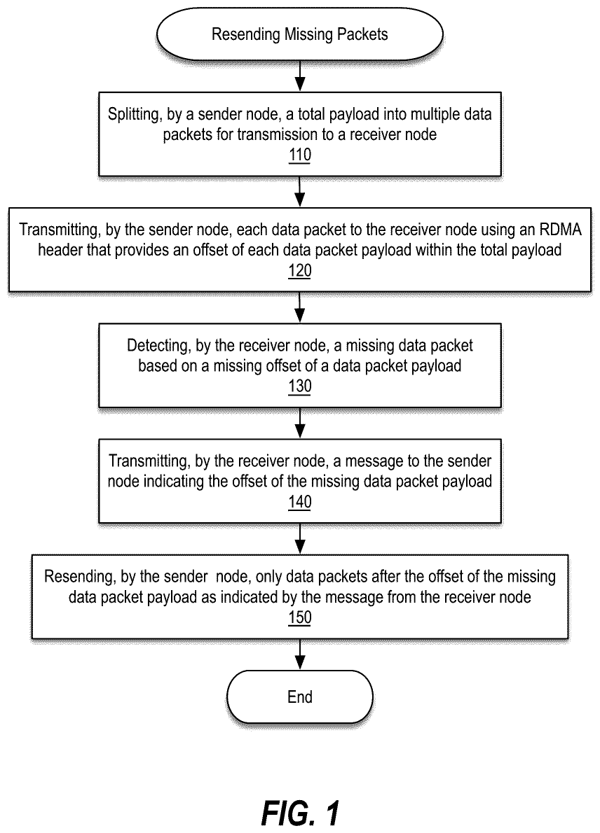

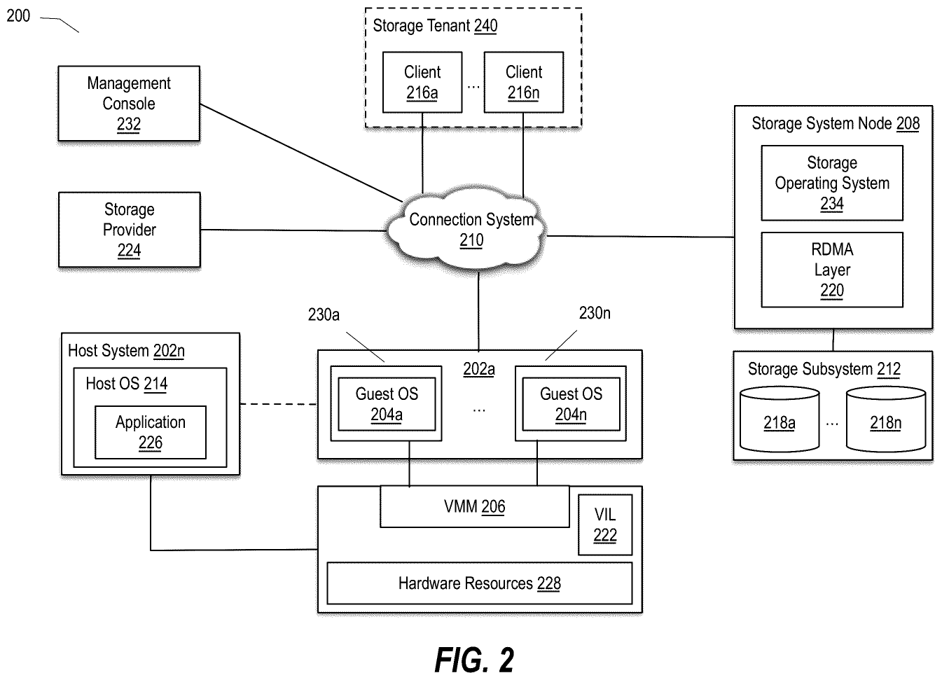

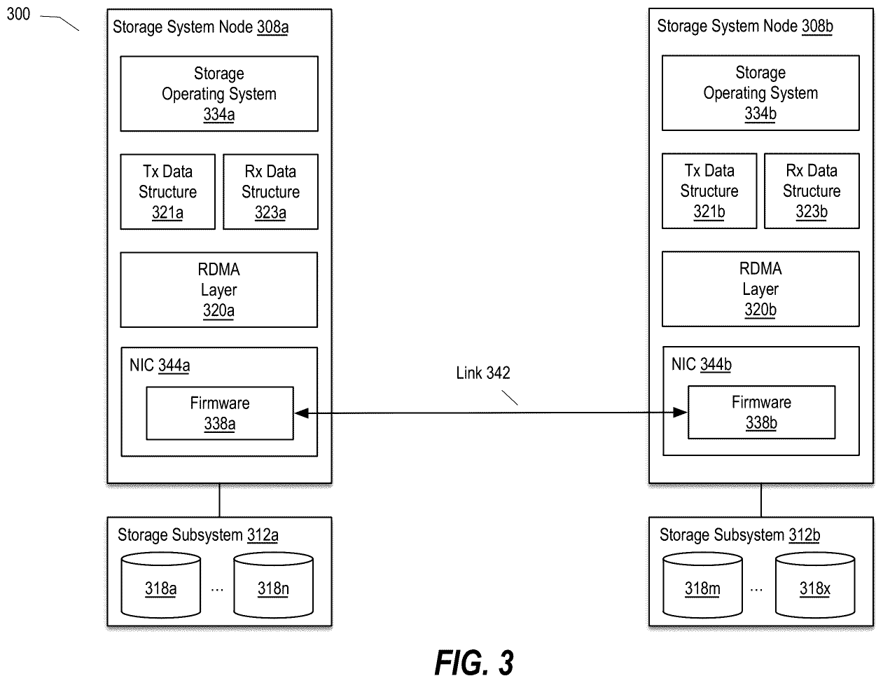

FIG. 1 is a flow diagram illustrating operations for resending missing packets during a network transmission in accordance with an embodiment of the present disclosure. The processing described with respect to FIG. 1 may be performed during network communication between storage nodes (e.g., storage system nodes 308a and 308b of FIG. 3, described below in detail). The same process may also be used for communication between a client system (e.g., one of clients 216a-n of FIG. 2) and a storage server (e.g., storage system node 208 of FIG. 2) or a host server (e.g., one of host systems 202a-n of FIG. 2). In various examples described herein the source of the RDMA data transmission may be referred to as a sender node and the destination of the RDMA data transmission may be referred to as a receiver node.

According to one embodiment, the processing described in FIG. 1 may be performed after a network connection between the nodes at issue (e.g., a pair of storage nodes, a client system and a storage server, or a storage server and a host system) has been established. For example, after network interface cards (NICs) 338a and 338b of storage system nodes 301a and 308b, respectively, have established a network connection and an MTU size has been negotiated by the storage nodes. In one example, a Memory Region for an RDMA operation may also registered with a QP to establish a PD. The storage operating system (e.g., storage operating system 334a or 335b of FIG. 3) or any other application may define a payload that needs to be sent via a network link (e.g., network link 342 of FIG. 3).

At block 110, the sender node (e.g., storage system node 308a of FIG. 3) splits a total payload into multiple data packets (each of which may also be referred to herein as a data packet payload) for transmission to the receiver node (e.g., storage system node 308b of FIG. 3). For example, an RDMA layer (e.g., RDMA layer 320a of FIG. 3) may split the total payload into data packets such that each packet has a portion of the total payload. In one embodiment, the position of the data packet payload within the total payload is defined by an offset value (e.g., in bytes). The number of data packets will depend on the overall size of the total payload and the negotiated MTU. Continuing with the present example, the RDMA layer identifies each data packet and assigns the offset for each data packet payload. The offset, the data packet size and the total payload size are included in an RDMA header that is created by the RDMA layer. As a non-limiting example, each data packet may include the following in addition to a portion of the payload: Ethernet header, Internet Protocol, Version 4 (IPv4) header, a User Datagram protocol (UDP) header and an RDMA header. The RDMA header format is specified by the RDMA specification and may include multiple fields indicating a protocol, a version, packet type (e.g., Control packet, Data packet, or ACK/NACK packet), a request sequence number, a request length, an offset value in the request, a packet length (i.e., packet size), a destination address and other vendor specific information.

At block 120, the sender node transmits each data packet to the receiver node using the aforementioned RDMA header. For example, the sender node using its NIC and the network link coupling the sender node to the receiver node may transmit the data packets making up the total payload. In one embodiment, the transmission is associated with a transaction identifier. The data packets can be sent using TCP/IP, UDP or any other protocol as appropriate for the established network connection. In various examples described herein, the sender node maintains a transmit (“Tx”) data structure (e.g., Tx data structure 321a of FIG. 3) that includes the transaction identifier, total payload size, and offset value of each data packet within the total payload. Table 1 below shows a non-limiting example of the contents of the Tx data structure, in which the transaction identifier is shown as T1, the total payload size for the transaction is X bytes and the offset value of each packet is shown as B0-Bn.

TABLE 1
Example Tx Data Structure

| Transaction ID | Total | Offset Value of Each | |
|---|---|---|---|
| (Tx_ID) | Payload Size | Data Packet | Other Fields |
| T1 | X Bytes | B0 | F0 |
| T1 | X Bytes | B1 | F1 |
| T1 | — | — | — |
| T1 | X Bytes | Bn | Fn |

At block 130, the receiver node receives the data packets from the sender node. In one embodiment, an RDMA layer (e.g., RDMA layer 320b of FIG. 3) of the receiver node tracks the offset of each incoming packet to detect a gap in an expected offset of the received data packets. As an example, the RDMA layer may use a receive (“Rx”) data structure (e.g., Rx data structure 323b of FIG. 3) to track the progress of received data packets associated with the transaction identifier. In one embodiment, the Rx data structure stores the transaction identifier and offset value of the received data packets. The RDMA layer is able to detect a missing packet in the data transfer because it is aware of the total payload size, the size and offset of each data packet. If a gap in the expected offset is detected, indicating a missing data packet payload, the RDMA layer concludes that a data packet is missing. Table 2 below shows an example of how a missing packet may be detected. Assume that the first received packet has an offset value of B0. The RDMA layer expects the next offset value to be B1, but instead receives a packet with the offset B2. The RDMA layer then concludes that the data packet with the offset value B1 is missing.

TABLE 2
Example Rx Data Structure in which a Data Packet
having Offset B1 is Missing

| Transaction ID | Total | Offset Value of | |
|---|---|---|---|
| (Tx_ID) | Payload Size | Received Packet | Other fields |
| T1 | X Bytes | B0 | F0 |
| T1 | X Bytes | B2 | F2 |
| T1 | — | — | — |
| T1 | X Bytes | Bn | Fn |

At block 140, after detecting the missing data packet payload, the receiver node sends a message to the sender node indicating the offset of the missing data packet payload. For example, the receiver node may send a NACK packet specifying the offset of the missing data packet payload. Alternatively, the receiver node may implicitly indicate the missing data packet payload by sending an ACK packet confirming receipt of those of the data packet payloads prior to the missing data packet payload. Continuing with the foregoing example, when the packet with offset B1 is missing, the NACK packet will include the offset B1 or the ACK packet will include the offset B0.

At block 150, the sender node determines that a data packet payload was missing based on the offset included in the message (e.g., a NACK packet or an ACK packet) received from the receiver node. The sender node may then use its Tx data structure to rebuild the data packets from the offset of the missing data packet payload to ensure that all packets after the missing packet are re-sent. The rebuilt data packets from the missing offset are then sent to the receiver storage node. Continuing with the above example, the sender node checks the Tx data structure to determine that the packet with offset B1 is missing. The RDMA layer of the sender node then rebuilds data packets using offset values from B1 to Bn.

Unlike conventional systems, the above-described missing packet resend processing does not resend the total payload. This saves network bandwidth and processor usage of the nodes at issue. Furthermore, because the receiver node detects a missing packet based on an offset value, it does not have to use packet identifiers or counters to count packets, which saves processing resources of the receiver node and simplifies the overall detection of a missing data payload packet. Furthermore, there are other advantages of using this missing packet resend approach, including reduced management overhead and simplified receive buffer operation; resolving any window sizing problem by using NACK packets; and a receive buffer for holding data packets can be sufficiently large and hence, complicated window-size tuning is not needed. The receive buffer in this context means memory used by the storage nodes to temporarily hold received data packets. Window size tuning is used in network communication, e.g., using the TCP protocol, where a receive window size is the amount of receive data (in bytes) that can be buffered during a network connection. The sender node sends an amount of data based on the window size, before it must wait for an acknowledgment and window update from the receiving host. The window size is tuned based on the sent and received data. This may be avoided by using the missing packet resend process described above.

### Example Operating Environment

FIG. 2 is a block diagram illustrating an example of an overall operating environment 200 for various aspects of the present disclosure. In the context of the present example, the operating environment 200 represents a networked storage environment, which may also be referred to as system 200, for implementing various aspects of the present disclosure. System 200 may include multiple computing devices 202a-202n (which may also be referred to individually as a host system, a computing device, or a server or collectively as host systems, computing devices, or servers)) communicably coupled via a connection system 210 (e.g., a local area network (LAN), wide area network (WAN), the Internet and/or others) to a storage system node 208 (which may also be referred to as a storage server, a storage controller, a storage system node, a storage node, and the like) that executes a storage operating system 234 for storing and retrieving data to and from a storage subsystem 212 having mass storage devices 218a-n. Although only a single storage system 208 is shown in this example, according to aspects of the present disclosure, system 200 may include multiple storage systems 208 arranged in one or more high-availability (HA) pairs, for example, as shown and described with reference to FIG. 3. The storage system 108 also executes an RDMA layer 220 for executing RDMA operations, described.

As an example, host system 202a may execute multiple virtual machines (VMs) in a virtual environment. Host 202n may execute one or more application 226, for example, a database application, an email application, or any other application type that makes use of the storage system 208 to store information in storage devices 218a-n. Host 202n executes an operating system 214, for example, a Windows based operating system, Linux, Unix and others (without any derogation of any third-party trademark rights) to control the overall operations of host 202n.

Clients 216a-n are computing devices that can access storage space at the storage system 208 via the connection system 210. A client may represent a computing system of or associated with a company, a department, a project unit or any other entity. Each client is uniquely identified and, optionally, may be a part of a logical structure called a storage tenant 240. The storage tenant 240 represents a set of users (which may be referred to as storage consumers) of a storage provider 224 (which may also be referred to as a cloud manager, where cloud computing is utilized) that provides access to storage system 208. Notably, aspects of the present disclosure are not limited to the use of a storage provider or a storage tenant, and instead, may be implemented for direct client access.

In one aspect, the storage operating system 234 has access to mass storage devices 218 of storage subsystem 212. The mass storage devices 218 may include solid state drives (SSDs), storage class memory, writable storage device media such as hard disk drives (HDD), magnetic disks, video tape, optical, DVD, magnetic tape, and/or any other similar media adapted to store electronic information. The storage devices 218 may be organized as one or more groups of Redundant Array of Independent (or Inexpensive) Disks (RAID). The various aspects disclosed herein are not limited to any specific storage device type or storage device configuration.

As an example, the storage operating system 234 may provide a set of logical storage volumes (or logical unit numbers (LUNs)) that present storage space to host systems 202, clients 216, and/or VMs (e.g., 230a-n) for storing information. The volumes may be configured to store data containers (e.g., files, directories, structured or unstructured data, or data objects), scripts, word processing documents, executable programs, and any other type of structured or unstructured data. From the perspective of one of the client systems, each volume can appear to be a single drive. However, each volume can represent storage space at one storage device, an aggregate of some or all of the storage space in multiple storage devices, a RAID group, or any other suitable set of storage space.

A non-limiting example of storage operating system 234 is the Data ONTAP® storage operating system (available from NetApp, Inc. of San Jose, CA) that implements a Write Anywhere File Layout (WAFL®) file system (without derogation of any trademark rights of NetApp Inc.) or the CLOUD ONTAP® for executing the storage operating system 234 in the cloud. It is to be appreciated, various aspects disclosed herein are not limited to any specific file system type and maybe implemented by other file systems and storage operating systems.

The storage operating system 234 may organize storage space at the storage subsystem 212 as one or more “aggregates”, where each aggregate is identified by a unique identifier and a location. Within each aggregate, one or more storage volumes are created whose size can be varied. A quota-tree (qtree), sub-volume unit may also be created within the storage volumes. As a special case, a qtree may be an entire storage volume.

The storage system 208 may be used to store and manage information at storage devices 218. A request to store or read data may be based on file-based access protocols, for example, the Common Internet File System (CIFS) protocol or Network File System (NFS) protocol, over TCP/IP. Alternatively, the request may use block-based access protocols, for example, iSCSI (Internet Small Computer Systems Interface) and SCSI encapsulated over Fibre Channel (FCP). The term file/files as used herein include data container/data containers, directory/directories, and/or data object/data objects with structured or unstructured data.

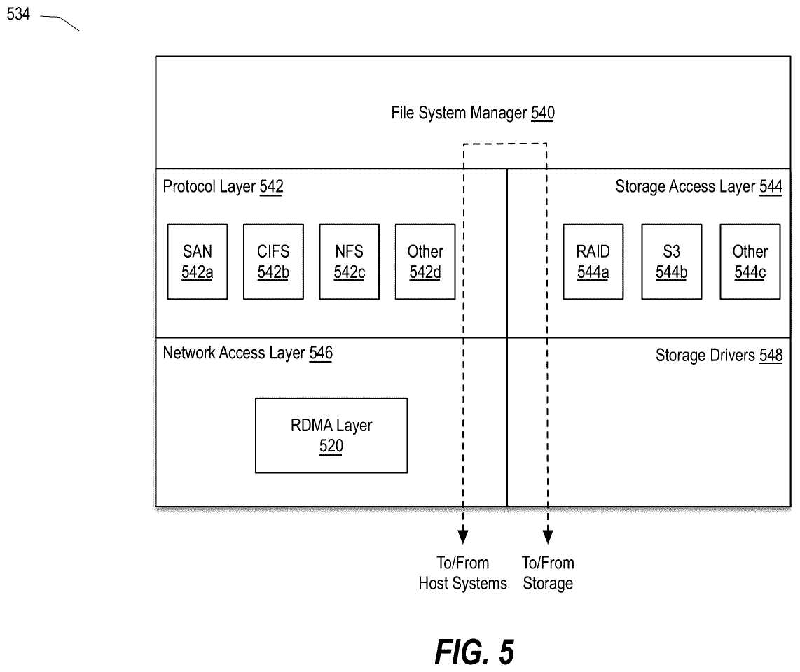

To facilitate access to storage space, the storage operating system 234 may implement a file system (which may be referred to as file system manager e.g., the file system manager 240 of FIG. 5) that logically organizes stored information as a hierarchical structure for files/directories/objects at the storage devices. The storage operating system 234 may further implement a storage module (for example, a RAID system for the storage subsystem 212) that manages the storage and retrieval of the information to and from storage devices 218 in accordance with input/output (I/O) operations.

In a typical mode of operation, a computing device (e.g., host system 202, client 216 or any other device) transmits (directly or indirectly) one or more I/O requests over connection system 210 to the storage system 208. Storage system 208 receives the I/O requests, issues one or more I/O commands to storage devices 218 to read or write data on behalf of the computing device, and issues a response containing the requested data over the network 210 to the respective client system.

As mentioned above, system 200 may also include a virtual machine environment where a physical resource is time-shared among multiple independently operating processor executable VMs. Each VM may function as a self-contained platform, running its own operating system (OS) and computer executable application software. The computer executable instructions running in a VM may be collectively referred to herein as “guest software.” In addition, resources available within the VM may be referred to herein as “guest resources.”

The guest software expects to operate as if it were running on a dedicated computer rather than in a VM. That is, the guest software expects to control various events and have access to hardware resources on a physical computing system (which may also be referred to as a host system) which may be referred to herein as “host hardware resources”. The host hardware resources may include one or more processors, resources resident on the processors (e.g., control registers, caches and others), memory (instructions residing in memory, e.g., descriptor tables), and other resources (e.g., input/output devices, host attached storage, network attached storage or other like storage) that reside in a physical machine or are coupled to the host system.

As shown in FIG. 2, host system 202a includes/provides a virtual machine environment executing multiple VMs 204a-n that may be presented to client computing devices/systems 216a-n. VMs 204 execute respective guest OSs 204a-n (which may also be referred to individually as a guest OS) that share hardware resources 228. Application 226 may also be executed within VMs 204 to access the storage system 208. As described above, hardware resources 228 may include storage, CPU, memory, I/O devices, and/or any other hardware resources.

In one aspect, host system 202a interfaces with or includes a virtual machine monitor (VMM) 206, for example, a processor executed Hyper-V layer provided by Microsoft Corporation of Redmond, Washington, a hypervisor layer provided by VMWare Inc., or any other type (without derogation of any third-party trademark rights). VMM 206 presents and manages the guest OSs 204a-n executed by the host system 202a. The VMM 106 may include or interface with a virtualization layer (VIL) 222 that provides one or more virtualized hardware resource to each guest OS 204a-n.

In one aspect, VMM 206 is executed by host system 202A with VMs 230. In another aspect, VMM 206 may be executed by an independent stand-alone computing system, referred to as a hypervisor server or VMM server and VMs 230 are presented at one or more computing systems.

It is noteworthy that different vendors provide different virtualization environments, for example, VMware Corporation, Microsoft Corporation, and others. Data centers may have hybrid virtualization environments/technologies, for example, Hyper-V and hypervisor based virtual environments. The generic virtualization environment described above with respect to FIG. 2 may be customized to implement the various aspects of the present disclosure. Furthermore, VMM 126 (or VIL 222) may execute other modules, for example, a storage driver, network interface and others. The virtualization environment may use different hardware and software components and it is desirable for one to know an optimum/compatible configuration.

In one aspect, system 200 uses a management console 232 for configuring and managing the various components of system 200. As an example, the management console 232 may be implemented as or include one or more application programming interfaces (APIs) that are used for managing one or more components of system 200. The APIs may be implemented as Representational State Transfer (REST) APIs. REST is a scalable system used for building web services. REST systems/interfaces may use hypertext transfer protocol (HTTP) or other protocols for communicating with one or more devices of system 200.

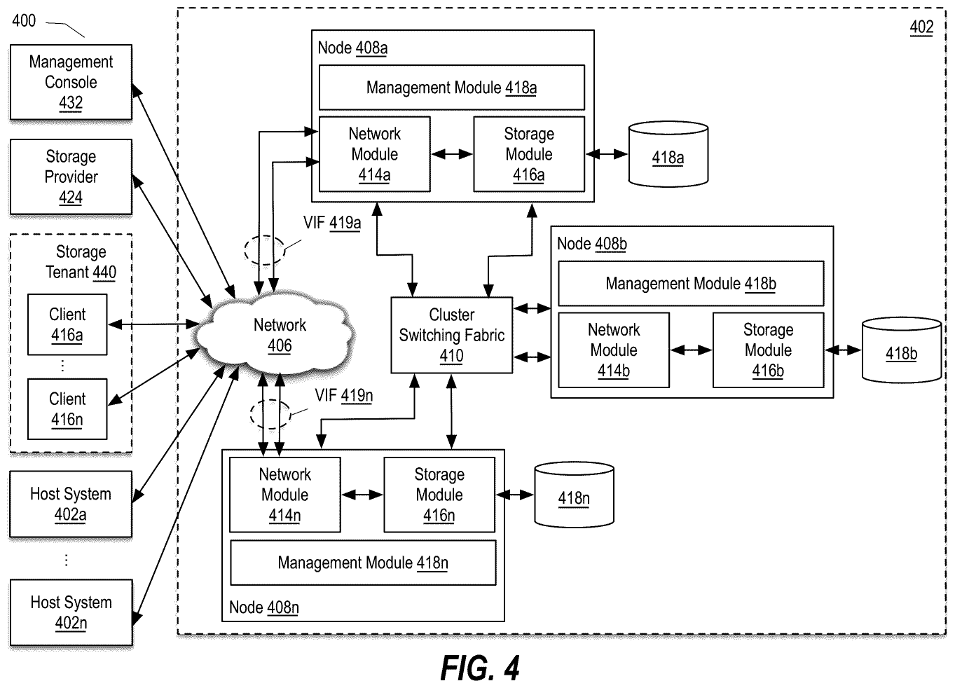

Although storage system 208 is shown as a stand-alone system (e.g., a non-cluster-based system,) in another aspect, storage system 208 may have a distributed architecture; for example, a cluster-based storage system as described below with reference to FIG. 4.

### Example Distributed Storage System

FIG. 3 is a block diagram illustrating an example of two storage system nodes 308a-b operating as partner nodes in accordance with an embodiment of the present disclosure. Depending on the particular implementation, one or more of the storage system nodes 308a-b may represent components of or may be analogous to storage system 208 In the context of the present example, storage system nodes 208a-b are shown connected by a network link (e.g., link 342), which may be an Ethernet link or any other communication or interconnect type. In this example, the storage system modes 208a-b are configured to operate as partner nodes in an HA configuration 300 and execute RDMA operations described above with respect to FIG. 1. This means that any data written by one storage system node (e.g., storage system node 308a) can be mirrored at the partner storage system node (e.g., e.g., storage system node 308b) using an RDMA operation. If one storage system node fails (e.g., storage system node 308a), then the other partner storage system node (e.g., storage system node 308b) takes over the storage volumes/LUNs of the failed storage system node during a failover operation that may also referred to as a “takeover operation”.

Each storage system node 308a/308b is shown with a respective storage operating system 334 (which may be analogous to storage operating system 234. To protect against failures, each storage system node persistently stores a log, which may be referred to as an “NVLog”, to track each write operation that is being processed by the buffer cache of each storage system node at any given time. During a failover operation, the storage volumes of a failed storage system node (e.g., storage system node 308a) are made available to incoming read and write requests by the partner storage system node (e.g., storage system node 308b).

In one aspect, storage nodes 308a-b includes respective NICs 344a-b that execute respective firmware instructions 338a-b to receive data and instructions from the associated RDMA layer 320a-b to transfer and/or receive data packets to and/or from the other storage node, for example, as described above with reference to FIG. 1. Storage nodes 308a-b are also shown including respective storage subsystems 312a-b (which may be analogous to storage subsystem 212) that manage storage and retrieval of information to and from storage devices 318a-n and 318m-x, respectively.

In this example, the storage system nodes 308a-b are shown maintaining respective Tx data structures 321a-b, for example, within a memory at a predetermined or configurable memory location. When storage system node 308a is operating as a sender node, Tx data structure 321a stores a transaction identifier identifying a data transfer between storage node 308a and storage node 308b (operating as a receiver node). The TX data structure 321a may also include an overall payload size and an offset value indicating the offset of each data packet within the overall payload, as described above with respect to Table I.

In this example, the storage system nodes 308a-b are also shown maintaining respective Rx data structures 323a-b. While operating as a receiver node, storage node 308b maintains Rx data structure 323b that stores a transaction identifier and an offset value of each received data packet. The Rx data structure 323b enables the storage node 308b to detect a missing packet, as described above with respect to Table 2. The storage node 308b also maintains a Tx data structure 321b, similar to 331a for data packets that are transmitted by the storage node 308b to the storage node 308a. The storage node 308a further maintains an Rx data structure 323a, similar to 323b to detect any missing data packets by tracking offset values of received data packets from the storage node 308b.

### Example Clustered Storage System

FIG. 4 is a block diagram illustrating an example of a clustered storage system 402 with multiple storage system nodes in accordance with an embodiment of the present disclosure. In the context of FIG. 4, a cluster-based storage environment 400 is shown having multiple storage system nodes 408a-n operating to store data on behalf of clients 416a-n (which may be analogous to clients 216a-n). The various storage system nodes may be configured to operate as partner nodes, for example, as described above with reference to FIG. 3. Any data packets that are missing during network communication may be processed using the process flow of FIG. 1.

Storage environment 400 may include multiple client systems 416a-n as part of or associated with a storage tenant 440 (which may be analogous to storage tenant 240), the clustered or distributed storage system 402 (which may be analogous to storage system 208) and at least a network 406 communicably connecting the host systems 402a-n (which may be analogous to host systems 202a-n), a management console 432 (which may be analogous to management console 232), and a storage (or cloud) provider 424 (which may be analogous to storage provider 224. It is noteworthy that these components may interface with each other using more than one network having more than one network device.

In this example, the clustered storage system 402 is shown including multiple storage system nodes 408a-n (which may also be referred to collectively as nodes or individually as a node), a cluster switching fabric 410, and multiple mass storage devices 418a-c (which may be similar to storage devices 118a-n and/or storage devices 318a-n and/or 318-m-x). The nodes 408a-n can be configured as HA pairs to operate as partner nodes, as shown in FIG. 3. For example, nodes 408a and 208b may operate as partner nodes. If node 408a fails, node 408b takes over the storage volumes that are exposed by node 408a during a failover operation.

Each of the plurality of nodes 408a-n is configured to include respective network module 414a-n, storage modules 416a-n, and management modules 418a-n, each of which can be implemented as a processor executable module.

The network modules 414a-n may include functionality that enable the respective nodes 408a-n to connect to one or more of the host systems 402a-n, and the client systems 416a-n (or the management console 432) over the computer network 406. In one embodiment, the network modules 414a-n handle file network protocol processing (for example, CFS, NFS and/or iSCSI requests). The storage modules 416a-n connect to one or more of the storage devices 418a-n and process I/O requests. Accordingly, each of the nodes 408a-n in the clustered storage server arrangement provides the functionality of a storage server.

The management modules 418a-n provide management functions for the clustered storage system 402. The management modules 418a-n may collect storage information regarding storage devices 418a-n.

A switched virtualization layer including multiple virtual interfaces (VIFs) (e.g., VIFs 419a-n) is provided to interface between the respective network modules 414a-n and the client systems 416a-n, allowing storage space at the storage devices associated with the nodes 408a-n to be presented to the client systems 416a-n as a single shared storage pool.

The clustered storage system 4-2 can be organized into any suitable number of storage virtual machines (SVMs) (which may be referred to as virtual servers), in which each SVM represents a single storage system namespace with separate network access. An SVM may be designated as a resource on system 400. Each SVM has a client domain and a security domain that are separate from the client and security domains of other SVMs. Moreover, each SVM is associated with one or more VIFs 419 and can span one or more physical nodes, each of which can hold one or more VIFs 419 and storage associated with one or more SVMs. Client systems can access the data on an SVM from any node of the clustered system, through the VIF(s) 419 associated with that SVM.

Each of the nodes 408a-n is defined as a computing system to provide services to one or more of the client systems 416a-n and/or host systems 402a-n. The nodes 408a-n are interconnected by the switching fabric 410, which, for example, may be embodied as a Gigabit Ethernet switch or any other type of switching/connecting device.

Although FIG. 4 depicts an equal number of network modules 414a-n, storage modules 416a-n, and management modules 418a-n, there may also be different numbers of network modules, storage modules, and/or management modules within the clustered storage system 402. For example, in alternative aspects, the clustered storage system 402 may include multiple network modules and multiple storage modules interconnected in a configuration that does not reflect a one-to-one correspondence between the network modules and storage modules. In another aspect, the clustered storage system 402 may only include one network module and storage module.

Each client system 416a-n may request the services of one of the respective nodes 408a-n, and that node may return the results of the services requested by the client system by exchanging packets over the computer network 406, which may be wire-based, optical fiber, wireless, or any other suitable combination thereof.

### Example Storage Operating System

FIG. 5 is a block diagram illustrating an example of a storage operating system 534 executed by a storage system node in accordance with an embodiment of the present disclosure. Storage operating system 534 may be analogous to storage operating system 234 or 334. In one example, storage operating system 534 may include several modules, or “layers” executed by one or both of a network module (e.g., one of network modules 414a-n) and a storage module (e.g., one of storage modules 416a-n). These layers include the file system manager 540 that keeps track of a hierarchical structure of the data stored in storage devices (e.g., storage devices 218, 318, or 418) and manages read/write operations, for example, by executing the read/write operations on storage in response to I/O requests.

Storage operating system 534 may also include a protocol layer 542 and an associated network access layer 546, to allow the associated node (e.g., node 208, one of nodes 308a-b, or one of nodes 408a-n) to communicate over a network with other systems, such as clients (e.g., clients 216a-n, clients 316a-n, or clients 416a-n). Protocol layer 542 may implement one or more of various higher-level network protocols, including but not limited to SAN 542a (e.g., iSCSI), CIFS 542b, NFS 542c, Hypertext Transfer Protocol (HTTP) (not shown), TCP/IP (not shown) and others 542d.

Network access layer 546 may include one or more drivers, which implement one or more lower-level protocols to communicate over the network, such as Ethernet. Interactions between host systems and mass storage devices are illustrated schematically as a path, which illustrates the flow of data through storage operating system 534. In one aspect, an RDMA layer 520 (which may be analogous to RDMA layer 220 or 320) is executed within the network access layer 546.

The storage operating system 534 may also include a storage access layer 544 and an associated storage driver layer 548 to allow a storage module (e.g., one of storage modules 416a-n) to communicate with a storage device. The storage access layer 544 may implement a higher-level storage protocol, for example, RAID 544a, an S3 layer 544b to access a capacity tier for object-based storage (not shown), and other layers 544c. The storage driver layer 548 may implement a lower-level storage device access protocol, for example, Fibre Channel or SCSI. The storage driver layer 548 may maintain various data structures (not shown) for storing information regarding storage volume(s), aggregate(s) and various storage devices.

In addition, it will be understood to those skilled in the art that the disclosure described herein may apply to any type of special-purpose (e.g., file server, filer or storage serving appliance) or general-purpose computer, including a standalone computer or portion thereof, embodied as or including a storage system. Moreover, the teachings of this disclosure can be adapted to a variety of storage system architectures including, but not limited to, a network-attached storage environment, a storage area network and a storage device directly attached to a client or host computer. The term “storage system” should therefore be taken broadly to include such arrangements in addition to any subsystems configured to perform a storage function and associated with other equipment or systems. It should be noted that while this description is written in terms of a write anywhere file system, the teachings of the present disclosure may be utilized with any suitable file system, including a write in place file system.

### Example Immediate ACK Processing

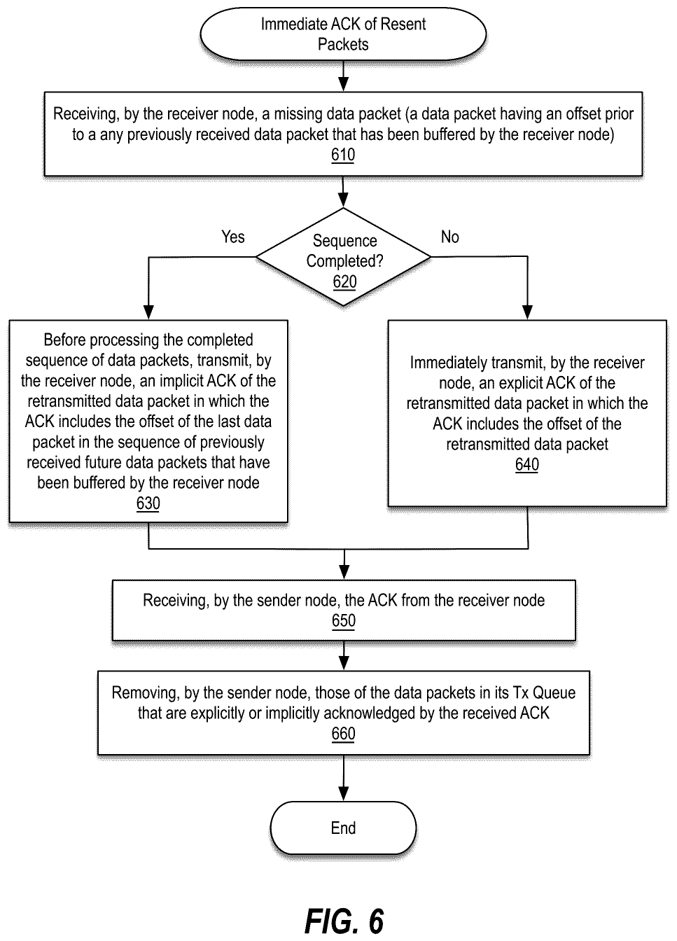

FIG. 6 is a flow diagram illustrating operations for performing an immediate ACK of resent packets in accordance with an embodiment of the present disclosure. Various portions of the processing described with reference to FIG. 6 may be performed by a receiver node (e.g., one of nodes 308a-b or one of nodes 408a-n) and a sender node (the other of nodes 308a-b or another of nodes 408a-n, representing the HA partner of the receiver node).

At block 610, a missing data packet of a data payload is received by the receiver node. As noted above, the receiver node may identify the missing data packet as such by comparing the offset associated with the missing data packet with the offsets of previously received data packets of the data payload that have not yet been processed by the receiver node and that have been buffered by the receiver node, for example, in a future data structure (e.g., a future queue of buffer). Generally, an offset of a missing data packet is less than that of the data packets in the future data structure.

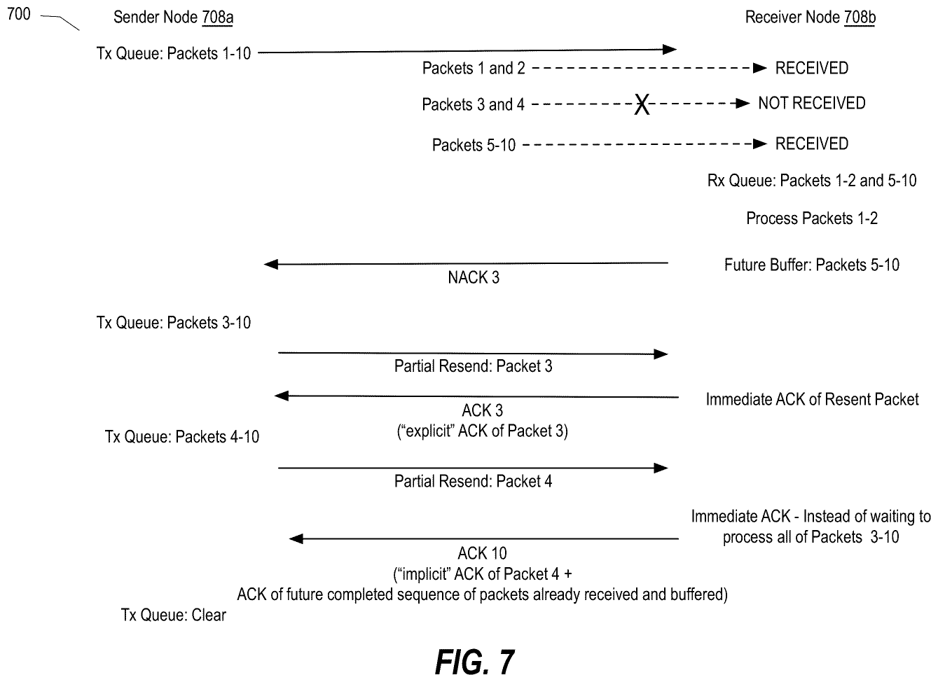

At decision block 620, a determination is made regarding whether the missing data packet completes a continuous sequence of packets sufficient to allow the receiver to process the sequence of packets. If so, processing continues with block 630; otherwise, processing branches to block 640. In either case, immediate ACK processing is performed in an attempt to quickly acknowledge receipt of this retransmitted data packet to the sender. For example, as described below with reference to FIG. 7, initially packets 3 and 4 of packets 1-10 sent by a sender node 708a to a receiver node 708b are not received by the receiver node 708b. As such, the receiver node 708b may process the continuous sequence of packets 1-2 and buffers packets 5-10 until the gap in the continuous sequence of packets 3-10 created by missing data packets 3 and 4 has been completed. With continuing reference to FIG. 7, after the partial resend of packets 3 and 4 by the sender node 708a to the receiver node 708b, the receiver node 708b determines the gap (i.e., the initial missing portion (3 and 4) of the sequence 3-10) has been addressed as it now has the complete continuous sequence of packets 3-10.

At block 630, before processing the completed sequence of data packets, the receiver node transmits an implicit ACK of the retransmitted data packet in which the ACK includes the offset of the last data packet in the sequence of previously received future data packets that have been buffered by the receiver node. Thus, the implicit ACK implicitly acknowledges receipt of all data packets of the completed sequence. For example, in the context of FIG. 7, after receipt of the partial resend of packet 4 from the sender node 708a to receiver node 708b, the receiver node 708b is shown sending an immediate ACK in the form of an implicit ACK of packet 4 by confirming receipt of all packets up to and including packet 10 by simply acknowledging receipt of packet 10. For instance, the implicit ACK may include an explicit reference to packet 10 (e.g., an offset value indicating packet 10's position within the transaction payload) but no explicit reference to packet 4. As those skilled in the art will appreciate, by sending an acknowledgement of receipt of packet 10 by the recipient node 708b to sender node 708a, the recipient node 708b is implicitly acknowledging receipt of all prior packets (i.e., packets 4-9) yet to have been acknowledged, as well as packet 10.

At block 640, the receiver node immediately transmits an explicit ACK of the retransmitted data packet in which the ACK includes the offset of the retransmitted data packet. For example, in the context of FIG. 7, after receipt of the partial resend of packet 3 from the sender node 708a to receiver node 708b, the receiver node 708b is shown sending an immediate ACK in the form of an explicit ACK of packet 3 that contains an explicit reference to packet 3 (e.g., an offset value indicating packet 3′s position within the transaction payload).

As mentioned above, the performance of immediate ACKs of resent data packets received by the receiver node may cause the receiver node to send more frequent ACKs to the sender node. One approach to mitigate the increased network traffic resulting from the more frequent ACKs is for the receiver node to piggyback the immediate ACKs on to other packets that would otherwise be sent from the receiver to the sender. For example, the receiver node may concurrently be operating as a sender and mirroring data to the sender node (concurrently operating as a receiver). In such a scenario, the receiver node (operating as a sender), may piggyback immediate ACKs on to data packets being sent to the sender node. Additionally or alternatively, the receiver node may piggyback immediate ACKs on to heartbeat packets the receiver node periodically transmits to the sender node-at least for those channels that carry heartbeat packets. The packet resulting from piggybacking an immediate ACK onto a data packet or onto a heartbeat may be referred to herein as a piggyback ACK. In one example, the piggyback ACK is essentially a data packet or a heartbeat packet that includes an acknowledgement (ACK) field, for example, within its header in which the ACK field includes the appropriate packet offset depending on whether the piggyback ACK represents an implicit or explicit ACK.

Depending on the particular implementation and/or on the traffic patterns between the sender node and the receiver node, the immediate ACKs may be selectively sent as standalone packets separate and independent from other data packets and/or heartbeat packets or may be piggybacked on such other data packets or heartbeat packets. For example, in one embodiment, when an immediate ACK is called for it may be sent as a standalone ACK packet if a data packet or heartbeat packet is not currently queued for transmission on the channel through which the immediate ACK is to be sent; however, if a data packet or heartbeat packet is currently queued for transmission on the channel through which the immediate ACK is to be sent, then the immediate ACK may be piggybacked onto the queued packet by replacing the queued packet with a piggyback ACK. In other examples, the use of piggyback ACKs or standalone ACKs may be explicitly authorized and/or precluded via one or more configuration parameters. In one embodiment, the one or more configuration parameters may be initialized and/or updated by an administrator of the storage cluster. In some examples, the one or more configuration parameters may be dynamically changed responsive to observed traffic patterns between the sender node and the receiver node.

At block 650, the sender node receives the ACK from the receiver node.

At block 660, the sender node removes those of the data packets in its Tx queue (e.g., Tx data structure 321a or 321b) that are explicitly or implicitly acknowledged by the received ACK. As noted above, as a result of the receiver node immediately acknowledging receipt of missing data packets to the sender node, the sender node is able to more quickly remove data packets from its Tx queue, thereby allowing the sender to continue to be responsive to clients. As additionally noted above, as the sender node would otherwise continue to resend the data packets in its Tx queue having offsets subsequent to the missing data packet, receipt of the immediate ACK (in the form of an implicit ACK or an explicit ACK) and clearing of data packets from its Tx queue may allow the sender node to avoid retransmission of one or more of the data packets subsequent to the missing data packet. In an ideal situation, the immediate ACK is received by the sender node before the sender node retransmits any data packets subsequent to the missing data packet, thereby avoiding the unnecessary retransmission of the subsequent data packets (which have already been received and buffered by the receiver node).

While in the context of the flow diagrams of FIGS. 1 and 6 a number of enumerated blocks are included, it is to be understood that examples may include additional blocks before, after, and/or in between the enumerated blocks. Similarly, in some examples, one or more of the enumerated blocks may be omitted and/or performed in a different order.

FIG. 7 is a message sequence diagram 700 illustrating example interactions between a sender node 708a (which may be analogous to one of nodes 308a-b or one of nodes 408a-n) and a receiver node 708b (which may be analogous to the other of nodes 308a-b or another of nodes 408a-n, representing the HA partner of the receiver node) in accordance with an embodiment of the present disclosure.

In the context of the present example, the sender node 708a has previously split a total payload into multiple data packets (e.g., packets having offsets 1-10, which may be referred to as packets 1-10, respectively) and has previously stored the multiple data packets to its Tx queue (e.g., Tx data structure 321a or 321b), for example, in accordance with block 110 of FIG. 1. The sender node 708a, then proceeds to transmit each of the multiple data packets to the receiver node 708b, for example, in accordance with block 120 of FIG. 1.

As shown on the right-hand side of FIG. 7, in the context of the present example, the receiver node 708b is assumed to have received packets 1 and 2 and packets 5-10, for example, in accordance with block 130 of FIG. 1, but has not received packets 3 and 4. As such, the receiver node queues packets 1-2 and 5-10 on its Rx queue (e.g., Rx data structure 323a or 323b), processes the completed sequence of packets 1-2, and buffers packets 5-10 in its future buffer pending receipt of missing packets 3-4.

As a result of detecting the missing packets, the receiver node 708b is shown sending a NACK for packet 3, for example, in accordance with block 140 of FIG. 1. As noted above, alternatively, the receiver node 708b may instead send an implicit ACK to acknowledge receipt of packets 1-2.

In response to receipt of the NACKs, the sender node 708a determines that packet 3 was not received by the receiver node 708b, removes packets 1-2 from its Tx queue, retaining packets 3-10 in the Tx queue for retransmission, and begins the partial resend process to retransmit packets 3-10 to the receiver node 708b, for example, in accordance with block 150 of FIG. 1.

Upon receipt of resent (missing) packet 3 by the receiver node 708b, the receiver node 708b is shown as immediately acknowledging the resent packet, for example, in accordance with block 640 of FIG. 6.

Based on receipt of the acknowledgement of receipt of packet 3, the sender node 708a removes packet 3 from its Tx queue and continues with its partial resend process by sending packet 4.

Upon receipt of resent (missing) packet 4 by the receiver node 708b, the receiver node 708b is shown as immediately acknowledging the continuous sequence of packets 4-10 before it processes packets 4-10, for example, in accordance with block 630 of FIG. 6.

In this example representing an ideal situation, based on receipt of the implicit acknowledgement of receipt of packets 4-9 and explicit acknowledgement of packet 10, the sender node 708a removes packet 4-10 from its Tx queue and avoids further unnecessary resending of subsequent packets 5-10.

### Alternative Embodiments

In one embodiment, in addition to or instead of the receiver node performing immediate ACK processing for resent data packets, the sender node may perform immediate resend processing. For example, if a data packet is not acknowledged within a predetermined or configurable period of time, the sender node may begin partial resend processing in an attempt to proactively missing data packets not received by the receiver node and reduce the amount of time data packets remain in the Tx queue of the sender node. In one embodiment, the sender node may start a timer for the predetermined or configurable period of time upon sending a given data packet (or a given set of data packets) to the receiver node. If this timer expires before receipt of an ACK from the receiver node, immediate resend processing for the given data packet (or the given set of data packets) may commence. Depending on the particular implementation, immediate resend processing may be dynamically enabled or disabled via one or more configuration parameters. In one embodiment, the one or more configuration parameters may be initialized and/or updated by an administrator of the storage cluster. In some examples, the one or more configuration parameters may be dynamically changed responsive to observed traffic patterns between the sender node and the receiver node.

In another embodiment, if the receiver node can notify the sender node about holes in the future queue, the sender node can retransmit only the missing packets instead of retransmitting both the missing and future packets in a manner similar to how selective acknowledgements (SACK) are used in TCP.

### Example Storage System Node

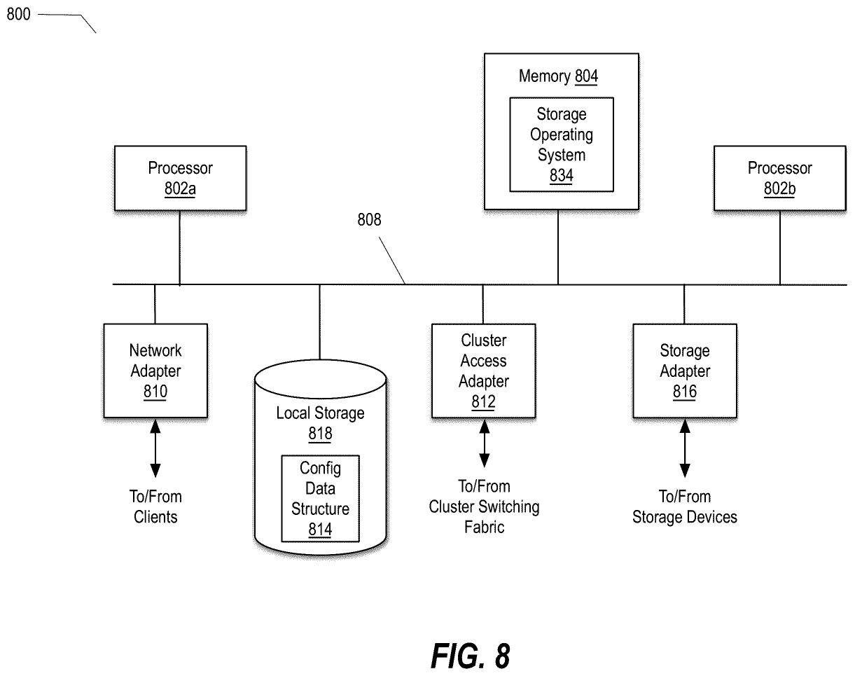

FIG. 8 is a block diagram illustrating an example of a storage system node 800 in accordance with an embodiment of the present disclosure. The storage system node 800 may be analogous to storage system node 208, one or storage system nodes 308a-b, and/or one or storage system nodes 408a-n. In this example, the storage system node 800 is illustratively embodied as a storage system comprising multiple processors 802a and 802b, a memory 804, a network adapter 810, a cluster access adapter 812, a storage adapter 816 and local storage 818 interconnected by a system bus 808.

Processors 802a-802b may be, or may include, one or more programmable general-purpose or special-purpose microprocessors, digital signal processors (DSPs), programmable controllers, application specific integrated circuits (ASICs), programmable logic devices (PLDs), or the like, or a combination of such hardware devices.

The local storage 818 comprises one or more storage devices utilized by the node 800 to locally store configuration information for example, in a configuration data structure 814.

The cluster access adapter 812 comprises multiple ports adapted to couple node 800 to other nodes of a storage cluster (e.g., cluster 402). In the illustrative aspect, Ethernet may be used as the clustering protocol and interconnect media, although it will be apparent to those skilled in the art that other types of protocols and interconnects may be utilized within the cluster architecture described herein. In alternate aspects where the network modules (e.g., network modules 414a-n) and storage modules (e.g., storage modules 416a-n) are implemented on separate storage systems or computers, the cluster access adapter 812 is utilized by the network/storage module for communicating with other network/storage modules in the cluster.

Storage nodes described herein may be illustratively embodied as a dual processor storage system executing an RDMA layer (e.g., RDMA layer 220 or 320), and the storage operating system 834 that preferably implements a file system (e.g., file system manager 540) or other high-level module to logically organize the information as a hierarchical structure of named directories and files in persistent storage (e.g., storage devices 218, 318, or 418). However, it will be apparent to those of ordinary skill in the art that the storage nodes may alternatively comprise single processor systems or more than two processor systems. Illustratively, one processor 802a may execute the functions of the network module on the node, while the other processor 802b may execute the functions of the storage module on the node.

The memory 804 illustratively comprises storage locations that are addressable by the processors and adapters for storing programmable instructions and data structures. The processor and adapters may, in turn, comprise processing elements and/or logic circuitry configured to execute the programmable instructions and manipulate the data structures. It will be apparent to those skilled in the art that other processing and memory means, including various computer readable media, may be used for storing and executing program instructions pertaining to the disclosure described herein.

The storage operating system 834, portions of which are typically resident in memory and executed by the processing elements, functionally organizes the node 800 by, inter alia, invoking storage operations in support of the storage service implemented by the node 800.

In one aspect, data that needs to be written is first stored at a buffer cache in memory 804. The written data is then stored to the persistent storage during a consistency point operation.

The network adapter 810 (which may be analogous to NIC 344a or 344b) may comprise multiple ports adapted to couple the node 800 to one or more clients (e.g., clients 216a-n or 416a-n) over point-to-point links, wide area networks, virtual private networks implemented over a public network (Internet) or a shared local area network. The network adapter 810 thus may comprise the mechanical, electrical and signaling circuitry needed to connect the node to the network for executing RDMA operations. Each client may communicate with the node 800 over a network (e.g., network 406) by exchanging discrete frames or packets of data according to pre-defined protocols, for example, TCP/IP.

The storage adapter 816 cooperates with the storage operating system 834 executing on the node 800 to access information requested by the clients. The information may be stored on any type of attached array of writable storage device media such as hard drives, solid state drives, storage class memory, video tape, optical, DVD, magnetic tape, bubble memory, electronic random-access memory, micro-electromechanical and any other storage media adapted to store information, including data and parity information. However, as illustratively described herein, the information is preferably stored within persistent storage. The storage adapter 816 may comprise multiple ports having input/output (I/O) interface circuitry that couples to the storage devices over an I/O interconnect arrangement (e.g., a conventional high-performance, Fibre Channel link topology).

### Example Processing System

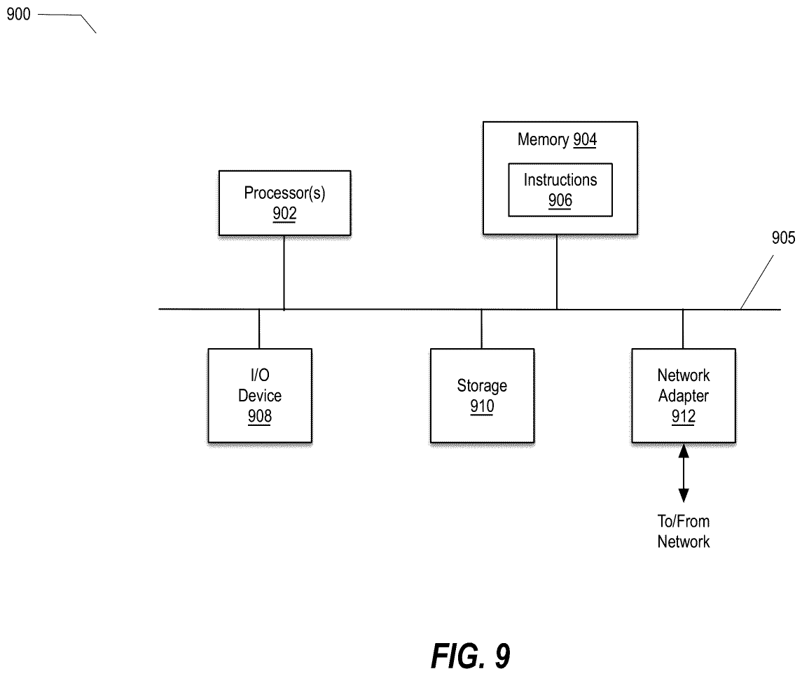

FIG. 9 is a block diagram illustrating an example of a processing system 900 that may be used according to various aspects of the present disclosure. The processing system 900 can represent a storage system node (e.g., storage system node 208, storage system node 308a or 308b, one of storage system modes 408a-n), a host system (e.g., host system 202 or host system 402a-n), a management console (e.g., management console 232 or 432), or a client (e.g., one or clients 216a-n or 416a-n). Note that certain standard and well-known components which are not germane to the present aspects are not shown in FIG. 9.

In the context of the present example, the processing system 900 includes one or more processor(s) 902 and memory 904, coupled to a bus system 905. The bus system 905 shown in FIG. 9 is an abstraction that represents any one or more separate physical buses and/or point-to-point connections, connected by appropriate bridges, adapters and/or controllers. The bus system 905, therefore, may include, for example, a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”).

The processor(s) 902 may represent the central processing units (CPUs) of the processing system 900 and, thus, may control its overall operation. In certain aspects, the processors 902 accomplish this by executing software stored in memory 904. The processors 902 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 904 may represent any form of random-access memory (RAM), read-only memory (ROM), flash memory, or the like, or a combination of such devices. Memory 904 includes the main memory of the processing system 900. Instructions 906 may be used to implement an RDMA layer (e.g., RDMA layer 220, 320a, or 320b) and the processing steps of the flow diagrams of FIGS. 1 and 6 described above, may reside in and be executed (by processors 902) from memory 904.

Also connected to the processors 902 through the bus system 905 are one or more internal mass storage devices 910, and a network adapter 912. Internal mass storage devices 910 may be or may include any conventional medium for storing large volumes of data in a non-volatile manner, such as one or more magnetic or optical based disks, solid state drives, or any other storage media. The network adapter 912 provides the processing system 900 with the ability to communicate with remote devices (e.g., storage servers) over a network and may be, for example, an RDMA adapter, Ethernet adapter, a Fibre Channel adapter, or the like.

The processing system 900 also includes one or more input/output (I/O) devices 908 coupled to the bus system 905. The I/O devices 908 may include, for example, a display device, a keyboard, a mouse, etc.

### Cloud Computing

The system and techniques described above are applicable and useful in the cloud computing environment. Cloud computing means computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. The term “cloud” is intended to refer to the Internet and cloud computing allows shared resources, for example, software and information to be available, on-demand, like a public utility.

Typical cloud computing providers deliver common business applications online which are accessed from another web service or software like a web browser, while the software and data are stored remotely on servers. The cloud computing architecture uses a layered approach for providing application services. A first layer is an application layer that is executed at client computers. In this example, the application allows a client to access storage via a cloud. After the application layer, is a cloud platform and cloud infrastructure, followed by a “server” layer that includes hardware and computer software designed for cloud specific services, for example, a storage system (e.g., storage system 208, storage system nodes 308a-b, and/or storage system nodes 408a-n) may be accessible as a cloud service. Details regarding these layers are not germane to the embodiments disclosed herein.

Embodiments of the present disclosure include various steps, which have been described above. The steps may be performed by hardware components or may be embodied in machine-executable instructions, which may be used to cause one or more processing resources (e.g., one or more general-purpose or special-purpose processors) programmed with the instructions to perform the steps. Alternatively, depending upon the particular implementation, various steps may be performed by a combination of hardware, software, firmware and/or by human operators.

Embodiments of the present disclosure may be provided as a computer program product, which may include a non-transitory machine-readable storage medium embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or standard computer hardware to execute the code contained therein. An apparatus for practicing various embodiments of the present disclosure may involve one or more computers (e.g., physical and/or virtual servers) (or one or more processors (e.g., processors 802a-b and/or processor(s) 902) within a single computer) and storage systems containing or having network access to computer program(s) coded in accordance with various methods described herein, and the method steps associated with embodiments of the present disclosure may be accomplished by modules, routines, subroutines, or subparts of a computer program product.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device (e.g., local storage 230). Volatile media includes dynamic memory, such as main memory (e.g., memory 224). Common forms of storage media include, for example, a flexible disk, a hard disk, a solid state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise a bus (e.g., system bus 808 or 905). Transmission media can also take the form of acoustic or light waves, such as those generated during radio-wave and infra-red data communications.

Various forms of media may be involved in carrying one or more sequences of one or more instructions to the one or more processors for execution. For example, the instructions may initially be carried on a magnetic disk or solid state drive of a remote computer. The remote computer can load the instructions into its dynamic memory and send the instructions over a telephone line using a modem. A modem local to the computer system can receive the data on the telephone line and use an infra-red transmitter to convert the data to an infra-red signal. An infra-red detector can receive the data carried in the infra-red signal and appropriate circuitry can place the data on bus. Bus carries the data to main memory (e.g., memory 404 or 904), from which the one or more processors retrieve and execute the instructions. The instructions received by main memory may optionally be stored on storage device either before or after execution by the one or more processors.

All examples and illustrative references are non-limiting and should not be used to limit the applicability of the proposed approach to specific implementations and examples described herein and their equivalents. For simplicity, reference numbers may be repeated between various examples. This repetition is for clarity only and does not dictate a relationship between the respective examples. Finally, in view of this disclosure, particular features described in relation to one aspect or example may be applied to other disclosed aspects or examples of the disclosure, even though not specifically shown in the drawings or described in the text.

The foregoing outlines features of several examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
receiving, by a receiver node, a plurality of data packets from a sender node, wherein a given data packet of the plurality of data packets includes a portion of data of a transaction payload being mirrored to the receiver node, wherein the sender node buffers within a transmit data structure those of the plurality of data packets for which receipt by the receiver node has yet to be acknowledged, and wherein the sender node and the receiver node provide access to storage via a cloud environment; and
facilitating, by the receiver node, freeing of space within the transmit data structure by acknowledging receipt of a data packet retransmitted by the sender node to the receiver node prior to the receiver node processing the retransmitted data packet.

2. The method of claim 1, wherein said acknowledging receipt comprises transmitting an acknowledgement (ACK) to the sender node in a form of an explicit ACK in which the ACK includes an offset value indicating a position of a portion of data carried by the retransmitted data packet within the transaction payload.

3. The method of claim 2, wherein the ACK comprises a standalone ACK packet.

4. The method of claim 2, wherein the ACK comprises a piggyback ACK in which the ACK is piggybacked within a heartbeat packet or a data packet.

5. The method of claim 1, wherein said acknowledging receipt comprises transmitting an ACK to the sender node in a form of an implicit ACK in which the ACK includes a first offset value indicating a position of a portion of data carried by a previously received data packet of the plurality of data packets within the transaction payload that is greater than a second offset value indicating a position of a portion of data carried by the retransmitted data packet within the transaction payload.

6. The method of claim 5, wherein the ACK comprises a standalone ACK packet.

7. The method of claim 5, wherein the ACK comprises a piggyback ACK in which the ACK is piggybacked within a heartbeat packet or a data packet.

8. The method of claim 1, further comprising, prior to transmission of the retransmitted data packet by the sender node to the receiver node:
identifying, by the receiver node, the retransmitted data packet as a missing data packet relating to the transaction payload; and
transmitting, by the receiver node, a message to the sender node containing information indicative of an offset value corresponding to a position of a portion of missing data within the transaction payload.

9. The method of claim 1, wherein the data packet retransmitted by the sender node to the receiver node is as a result of immediate resend processing performed by the sender node.

10. A distributed storage system comprising:
one or more processing resources; and
instructions that when executed by the one or more processing resources cause the distributed storage system to:
receive, by a remote direct memory access (RDMA) layer of a receiver node of the distributed storage system, a plurality of data packets from a sender node of the distributed storage system, wherein a given data packet of the plurality of data packets includes a portion of data of a transaction payload being mirrored to the receiver node and an offset value indicating a position of the portion of data within the transaction payload, wherein an RDMA layer of the sender node buffers within a transmit data structure those of the plurality of data packets for which receipt by the receiver node has yet to be acknowledged, and wherein the sender node and the receiver node provide access to storage via a cloud environment; and
facilitate, by the RDMA layer of the receiver node, freeing of space within the transmit data structure by acknowledging receipt of a data packet retransmitted by the RDMA layer of the sender node to the receiver node prior to the receiver node processing the retransmitted data packet.

11. The distributed storage system of claim 10, wherein said acknowledging receipt comprises transmitting an acknowledgement (ACK) to the sender node in a form of an explicit ACK in which the ACK includes an offset value indicating a position of a portion of data carried by the retransmitted data packet within the transaction payload.

12. The distributed storage system of claim 10, wherein the ACK is selectively transmitted as (i) a piggyback ACK in which the ACK is piggybacked within a heartbeat packet or within a data packet or (ii) a standalone ACK.

13. The distributed storage system of claim 10, wherein said acknowledging receipt comprises transmitting an acknowledgement (ACK) to the sender node in a form of an implicit ACK in which the ACK includes a first offset value indicating a position of a portion of data carried by a previously received data packet of the plurality of data packets within the transaction payload that is greater than a second offset value indicating a position of a portion of data carried by the retransmitted data packet within the transaction payload.

14. The distributed storage system of claim 13, wherein the ACK is selectively transmitted as (i) a piggyback ACK in which the ACK is piggybacked within a heartbeat packet or within a data packet or (ii) a standalone ACK.

15. The distributed storage system of claim 10, wherein the instructions further cause the one or more processors to, prior to transmission of the retransmitted data packet by the RDMA layer of the sender node to the receiver node:
identify, by the receiver node, the retransmitted data packet as a missing data packet relating to the transaction payload; and
transmit, by the receiver node, a message to the sender node containing information indicative of an offset value corresponding to a position of a portion of missing data within the transaction payload.

16. The distributed storage system of claim 10, wherein the data packet retransmitted by the RDMA layer of the sender node is as a result of immediate resend processing performed by the sender node.

17. A non-transitory machine readable medium storing instructions, which when executed by one or more processing resources of a distributed storage system, cause the distributed storage system to:
receive, by a remote direct memory access (RDMA) layer of a receiver node of the distributed storage system, a plurality of data packets from a sender node of the distributed storage system, wherein a given data packet of the plurality of data packets includes a portion of data of a transaction payload for delivery to the receiver node and an offset value indicating a position of the portion of data within the transaction payload, wherein an RDMA layer of the sender node buffers within a transmit data structure those of the plurality of data packets for which receipt by the receiver node has yet to be acknowledged; and
facilitate, by the RDMA layer of the receiver node, freeing of space within the transmit data structure by commencing processing a data packet retransmitted by the RDMA layer of the sender node to the receiver node after acknowledging receipt of the retransmitted data packet.

18. The non-transitory machine readable medium of claim 17, wherein said acknowledging receipt comprises:
transmitting an acknowledgement (ACK) to the sender node in a form of an explicit ACK in which the ACK includes an offset value indicating a position of a portion of data carried by the retransmitted data packet within the transaction payload; or
transmitting the ACK to the sender node in a form of an implicit ACK in which the ACK includes a first offset value indicating a position of a portion of data carried by a previously received data packet of the plurality of data packets within the transaction payload that is greater than a second offset value indicating the position of the portion of data carried by the retransmitted data packet within the transaction payload.

19. The distributed storage system of claim 17, wherein the ACK is selectively transmitted as (i) a piggyback ACK in which the ACK is piggybacked within a heartbeat packet or within a data packet or (ii) a standalone ACK.

20. The non-transitory machine readable medium of claim 17, wherein the instructions further cause the one or more processors to, prior to transmission of the retransmitted data packet by the RDMA layer of the sender node to the receiver node:
identify, by the receiver node, the retransmitted data packet as a missing data packet relating to the transaction payload; and
transmit, by the receiver node, a message to the sender node containing information indicative of an offset value corresponding to a position of a portion of missing data within the transaction payload.
